(19) United States
(12) Patent Application Publication
(10) Pub. No.: US 2005/0206115 A1
(43) Pub. Date: Sep. 22, 2005

(54) Wheelchair with a steering/driving device

(76) Inventors: Jung-Tien Lee, Tainan Hsien (TW); Ming-Kuan Yu, Tainan City (TW)

Correspondence Address: CHARLES E. BAXLEY, ESQ., 90 JOHN STREET, THIRD FLOOR, NEW YORK, NY, 10038, US

(21) Appl. No.: 10/805,912

(22) Filed: Mar. 22, 2004

(51) Int. Cl. B62B 9/04

(52) U.S. Cl. 280/250.1

(57) ABSTRACT

A wheelchair includes a main body having a main frame with two rear wheels, a connecting frame securely connected to two side frames of the main frame, and a steering/driving device. The steering/driving device includes a handlebar, a connecting member, a wheel frame connected to the handlebar, a front wheel rotatably mounted to the wheel frame, and a transmission mechanism. The connecting member includes a first end securely connected to a front end of the connecting frame and a second end pivotally connected to the handlebar. The transmission mechanism includes a transmission block and a transmission gear device. The transmission block is securely connected to the handlebar. The transmission gear device is coupled with a shaft of the front wheel. The wheelchair is moved forward when a user in the wheelchair manipulates the handlebar back and forth while providing a steering function of the wheelchair.

### BACKGROUND OF THE INVENTION

1. Field of the Invention

The present invention relates to a wheelchair. In particular, the present invention relates to a wheelchair with a steering/driving device to allow the user sitting in the wheelchair to steer easily while moving the wheelchair through operation of the steering/driving device.

2. Description of the Related Art

FIG. 7 of the drawings illustrates a typical conventional wheelchair comprising a main frame 1′, a seat upholstery 2′, two casters 3′, two large wheels 4′, and two push rims 41′ respectively, securely connected to the large wheels 4′. A user sitting in the wheelchair may manipulate the push rims 41′ to move the wheelchair. However, the user may be injured by the large wheels 4′ during manipulation of the push rims 41′. Further, the push rims 41′ are in contact with the ground and thus foul the user's hands. An electric motor and a battery may be used as a power source for driving the wheelchair, yet the user could not exercise his or her hands. Further, the wheelchair could not move when the battery fails to provide electricity sufficient to drive the electric motor.

### SUMMARY OF THE INVENTION

An object of the present invention is to provide a wheelchair that can be moved forward and steered by means of manipulating a steering/driving device.

In accordance with an aspect of the present invention, a wheelchair includes a main body, a connecting frame, and a steering/driving device. The main body includes a main frame, a seat upholstery, a back upholstery, and two rear wheels. The main frame includes two side frames to which the rear wheels are respectively, rotatably mounted. The connecting frame is securely connected to the side frames of the main frame and including a front end and a rear end.

The steering/driving device includes a handlebar, a connecting member, a wheel frame connected to the handlebar, a front wheel rotatably mounted to the wheel frame, and a transmission mechanism. The connecting member includes a first end securely connected to the front end of the connecting frame and a second end pivotally connected to the handlebar.

The transmission mechanism includes a transmission block and a transmission gear device. The transmission block is securely connected to the handlebar. The transmission gear device is coupled with a shaft of the front wheel. The wheelchair is moved forward when a user in the wheelchair manipulates the handlebar back and forth while providing a steering function of the wheelchair.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a wheelchair in accordance with the present invention.

FIG. 2 is an exploded perspective view of a steering/driving device of the wheelchair in accordance with the present invention.

FIG. 3 is a perspective view of the wheelchair in accordance with the present invention.

FIG. 4 is an enlarged side view, partly sectioned, of a portion of the steering/driving device.

FIG. 5 is a perspective view illustrating lifting of two arms of the wheelchair.

FIG. 6 is a side view illustrating operation of the wheelchair in accordance with the present invention.

FIG. 7 is a perspective view of a conventional wheelchair.

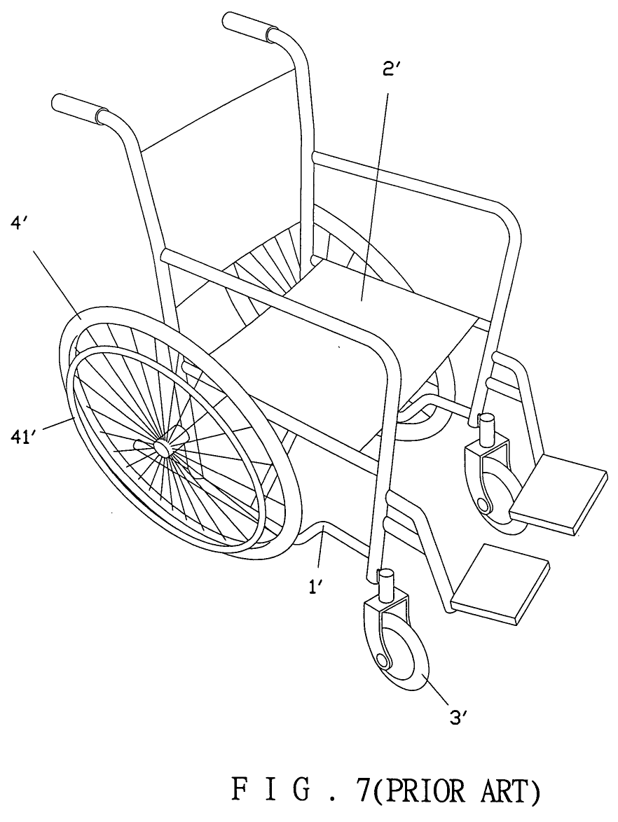

### DETAILED DESCRIPTION OF THE PREFERRED EMBODIMENT

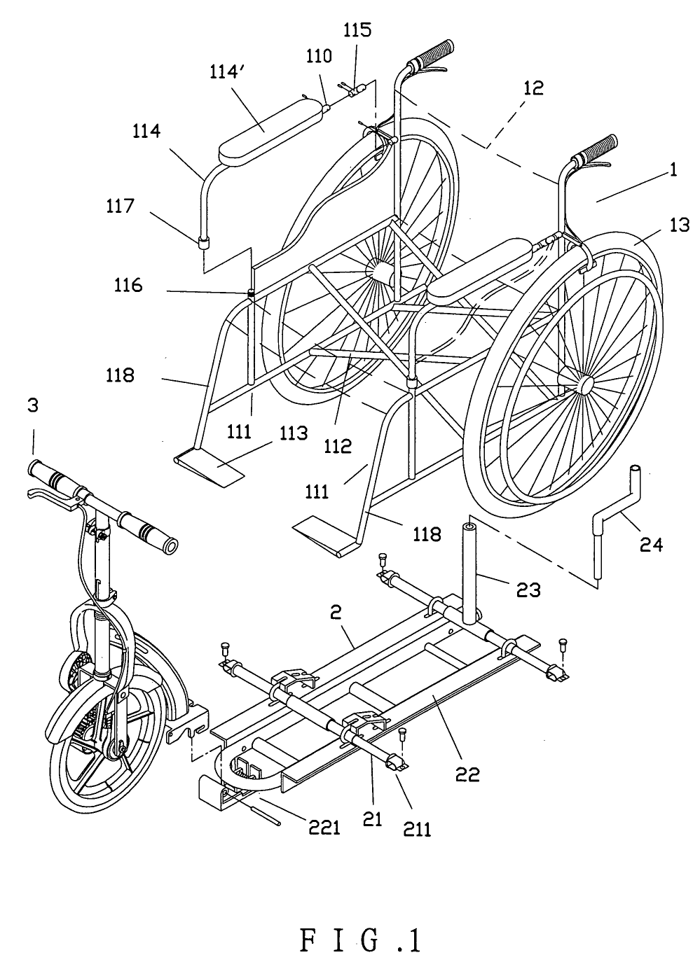

Referring to FIGS. 1, 3, and 5, a wheelchair in accordance with the present invention comprises a main body 1, a connecting frame 2, and a steering/driving device 3. The main body 1 includes a main frame 11, a back upholstery 12, a seat upholstery 12, and two rear wheels 13 respectively, rotatably mounted to two side frames 111 of the main frame 11. A plurality of connecting rods 112 are provided between the side frames 111, with the seat upholstery 12 and the back upholstery 12 mounted between the side frames 111. An arm 114 is provided on top of each side frame 111, and an armrest 114′ is attached to each arm 114. Each arm 114 includes a first end 110 to which a universal joint 115 is coupled and a second end 117 that is releasably and threadedly engaged with a stud 116 on an associated side frame 111. A hanger bracket 118 extends forward from each side frame 111, with a footplate 113 attached to a distal end of the hanger bracket 118.

The connecting frame 2 is mounted below the main frame 11 and includes a plurality of transverse beams 21 and a plurality of longitudinal beams 22. Each transverse beam 21 can be telescopic to allow adjustment of an overall length thereof in response to a distance between the side frames 111 of the main frame 11. Further, each transverse beam 21 includes an engaging end 211 for engaging with an associated side frame 111. Each longitudinal beam 22 is preferably orthogonal to the transverse beams 21. Preferably, the longitudinal beams 22 and the transverse beams 21 are located below a central portion of the main frame 11, with the transverse beams 21 being rotatable relative to the longitudinal beams 22. The longitudinal beams 22 have a common engaging portion 221 to which the steering/driving device 3 is mounted. An attachment member 23 may be mounted on a rear end of the connecting frame 2. An umbrella holder 24 is attached to the attachment member 23. Thus, the user may put an umbrella (not shown) on the umbrella holder 24, providing further convenience.

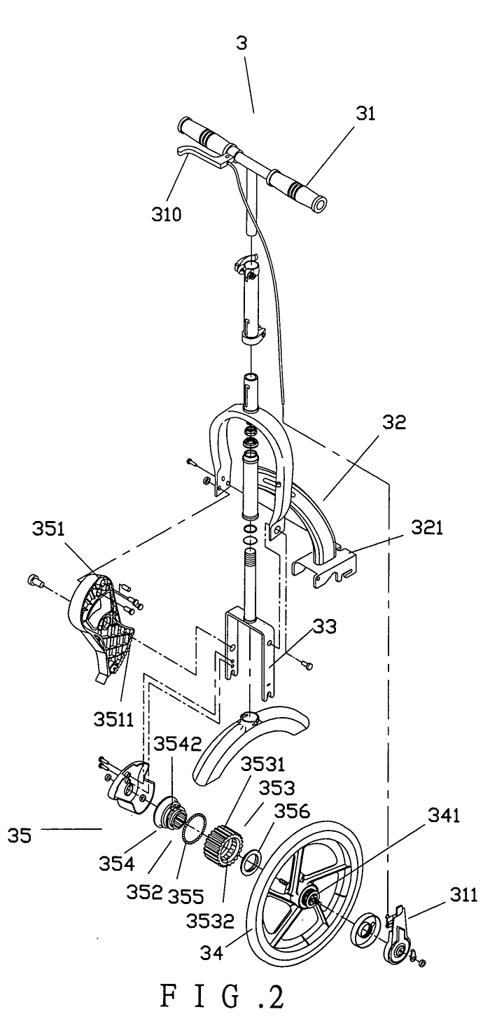

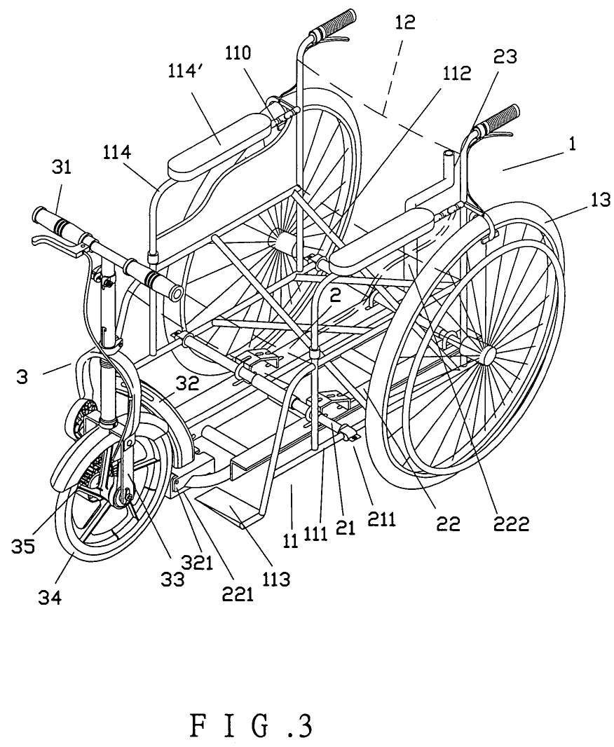

Referring to FIGS. 2 and 3, the steering/driving device 3 includes a handlebar 31, a connecting member 32, a wheel frame 33, a front wheel 34 rotatably mounted to the wheel frame 33, and a transmission mechanism 35. A lower end of the handlebar 31 is pivotally connected to the wheel frame 33 and fixedly connected to a transmission block 351 of the transmission mechanism 35. A brake 311 is mounted adjacent to the front wheel 34 and connected via a cable 312 to a brake lever 310 attached to the handlebar 31. The connecting member 32 has an engaging portion 321 on an end thereof for engaging with the common engaging portion 221 of the connecting frame 2. The other end of the connecting member 32 is pivotally connected to the wheel frame 33, allowing the wheel frame 33 to pivot relative to the connecting member 32. The front wheel 34 has a shaft 341 that is connected to the transmission mechanism 35.

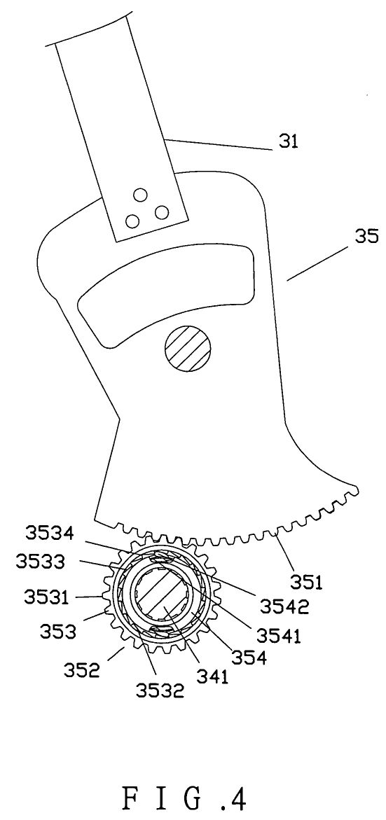

Referring to FIGS. 2 and 4, the transmission mechanism 35 includes the transmission block 351 and a transmission gear device 352. The transmission block 351 is pivotally connected to the wheel frame 3 and includes a toothed portion 3511 on an outer edge thereof. The transmission gear device 352 includes an inner gear 354 and an outer gear 353 mounted around the inner gear 354. The outer gear 353 includes a plurality of outer teeth 3531 on an outer periphery thereof for meshing with the toothed portion 3511 of the transmission block 351. The outer gear 353 further includes a plurality of inner teeth 3532 in an inner periphery thereof for meshing with the inner gear 354.

As illustrated in FIG. 4, at least one inclined face 3533 and a coupling portion 3534 are provided on the inner periphery of the outer gear 353. The inner gear 354 includes a central portion coupled to the shaft 341 of the front wheel 34 to turn therewith. A resilient ring 3541 and a movable tooth block 3542 are mounted on the outer periphery of the inner gear 354. The movable tooth block 3542 is coupled by the resilient ring 3541 and meshed with the inner teeth 3532 on the inner periphery of the outer gear 353. A plurality of balls 355 may be provided between the inner gear 354 and the outer gear 353 to provide smooth relative rotation therebetween. An end cap 356 may be mounted to a side of the inner gear 354 to improve assembling stability. When the coupling portion 3534 of the outer gear 353 moves toward the movable tooth block 3542 of the inner gear 354, the inner gear 354 is turned. When the inclined face 3533 of the outer gear 353 moves toward the movable tooth block 3542 of the inner gear 354, the movable tooth block 3542 is pressed and the inner gear 354 does not turn.

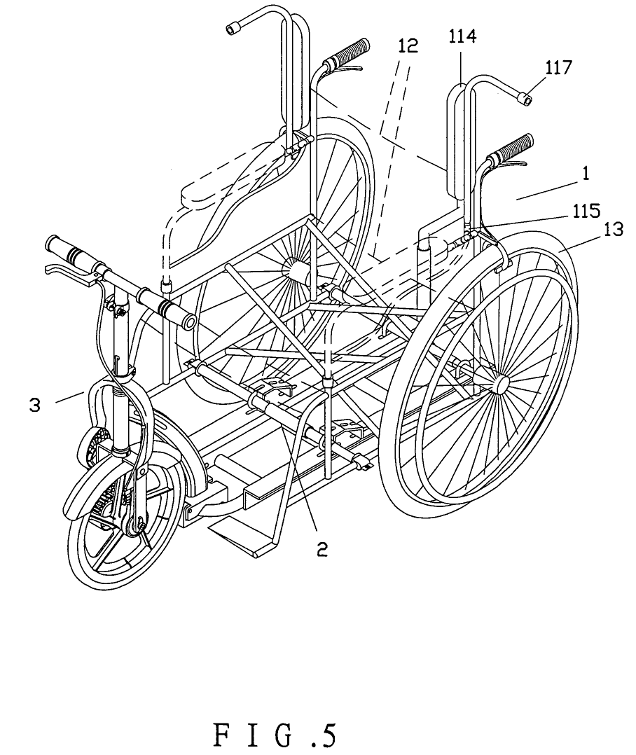

Referring to FIG. 5, when the user is intended to leave or get into the wheelchair, the second end 117 of one of the arms 114 is disengaged from the associated stud 116, and the arm 114 is then moved upward and outward, as the first end of the arm 114 and the associated side frame 111 are coupled together by a universal joint 115. Thus, the arm 114 can be moved to a position allowing the user to get out of or into the wheelchair.

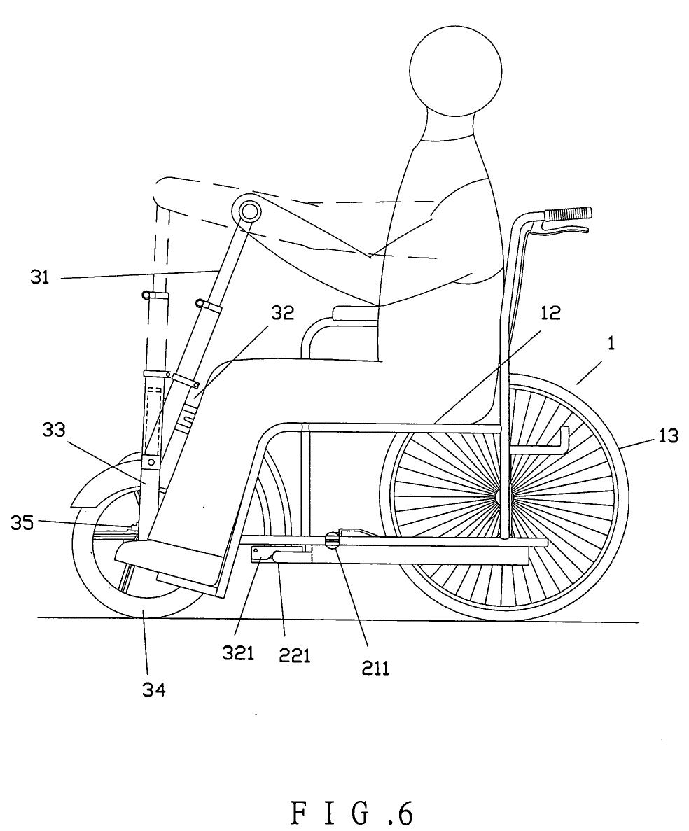

Referring to FIGS. 4 and 6, the user in the wheelchair may grip the handlebar 31 and move it back and forth. When the handlebar 31 moves rearward, the transmission block 351 and the outer gear 353 are actuated, which, in turn, causes the coupling portion 3534 of the outer gear 353 and the movable tooth block 3542 of the inner gear 354 to turn relative to each other. Thus, the inner gear 354, the shaft 341, and the front wheel 34 turn, causing forward movement of the wheelchair.

When the handlebar 31 moves forward, the inclined face 3533 of the outer gear 353 presses against the movable tooth block 3542 of the inner gear 354 such that the movable tooth block 3542 does not turn with the outer gear 353; namely, the movable tooth block 3542 turns idly. As a result, the inner gear 354 does not turn. By means of repeatedly moving the handlebar 31 back and forth, the wheelchair is moved forward while providing a steering function by the handlebar 31. Thus, the user in the wheelchair can exercise his or her arms. Further, the brake 311 (FIG. 3) may be used when desired.

In conclusion, the wheelchair in accordance with the present invention provides the following advantages:

1. The connecting frame 2 can be used with the main body 1 of various sizes.

2. Injury to the user's arms during rotations of the front wheel 34 and the rear wheels 13 of the wheelchair is impossible, as the user may manipulate the handlebar 31 while achieving an exercising function.

3. The wheelchair can be easily steered through manipulation of the handlebar 31.

4. The user may keep his or hands clean through use of the handlebar 31.

5. The wheelchair can be folded when not in use.

6. An umbrella can be removably attached to the wheelchair, providing a shield from the sun or rain.

Although the invention has been explained in relation to its preferred embodiment, it is to be understood that many other possible modifications and variations can be made without departing from the scope of the invention as hereinafter claimed.

1. A wheelchair comprising:
a main body including a main frame, a seat upholstery, a back upholstery, and two rear wheels, the main frame including two side frames to which the rear wheels are respectively, rotatably mounted;
a connecting frame securely connected to the side frames of the main frame and including a front end and a rear end; and
a steering/driving device including a handlebar, a connecting member, a wheel frame connected to the handlebar, a front wheel rotatably mounted to the wheel frame, and a transmission mechanism, the connecting member including a first end securely connected to the front end of the connecting frame and a second end pivotally connected to the handlebar, the front wheel having a shaft;
the transmission mechanism including a transmission block and a transmission gear device, the transmission block being securely connected to the handlebar, the transmission gear device being coupled with the shaft of the front wheel;
wherein the wheelchair is moved forward when a user in the wheelchair manipulates the handlebar back and forth while providing a steering function of the wheelchair.

2. The wheelchair as claimed in claim 1, wherein the connecting frame includes a plurality of transverse beams and a plurality of longitudinal beams, each said transverse beam is telescopic to allow adjustment of an overall length thereof in response to a distance between the side frames of the main frame.

3. The wheelchair as claimed in claim 2, wherein the transverse beams and the longitudinal beams are mounted below a central portion of the main frame.

4. The wheelchair as claimed in claim 3, wherein the longitudinal beams have a common engaging portion on front ends thereof for engaging with the connecting member of the steering/driving device.

5. The wheelchair as claimed in claim 1, further including an umbrella holder mounted on the rear end of the connecting frame.

6. The wheelchair as claimed in claim 1, wherein the transmission block is pivotally connected to the wheel frame and includes a toothed portion on an outer edge thereof, the transmission gear device including an inner gear and an outer gear mounted around the inner gear, the outer gear including a plurality of outer teeth on an outer periphery thereof for meshing with the toothed portion of the transmission block, the outer gear further including a plurality of inner teeth on an inner periphery thereof, the inner gear including a plurality of teeth on an outer periphery thereof for meshing with the inner teeth of the outer gear, the outer gear further including an inclined face and a coupling portion on the inner periphery thereof, the inner gear being coupled with the shaft of the wheel to turn therewith, a resilient ring and a movable tooth block being mounted on the outer periphery of the inner gear, the movable tooth block having an end meshed with the coupling portion of the outer gear;
wherein when the inner teeth of the outer gear move toward the movable tooth block of the inner gear, the inner gear is turned, thereby driving the front wheel forward; and
wherein when the inclined face of the outer gear moves toward the movable tooth block of the inner gear, the inner gear is not turned.

7. The wheelchair as claimed in claim 1, further including an arm mounted on top of each said side frame, each said arm including a first end coupled to an associated one of the side frames by a universal joint, each said arm including a second end for threadedly engaging with a stud on an associated one of the side frames.
